(19) United States
(12) Patent Application Publication
(10) Pub. No.: US 2021/0229154 A1
(43) Pub. Date: Jul. 29, 2021

(54) BENDING DEVICE FOR BENDING A WORKPIECE AS WELL AS METHOD FOR OPERATING SUCH A BENDING DEVICE

(71) Applicant: Siegmar Thieskes, Öhringen-Ohrnberg (DE)

(72) Inventor: Siegmar Thieskes, Öhringen-Ohrnberg (DE)

(73) Assignee: Sperr & Lechner Splek Maschinenbau GmbH & Co. KG, Öhringen-Ohrnberg (DE)

(21) Appl. No.: 17/161,325

(22) Filed: Jan. 28, 2021

(30) Foreign Application Priority Data
Jan. 28, 2020 (DE) 10 2020 200 971.6
Feb. 20, 2020 (DE) 10 2020 202 201.1

(51) Int. Cl. B21D 5/16; B26D 1/10

(52) U.S. Cl. CPC B21D 5/16; B26D 1/105

(57) ABSTRACT

A folding device for bending a workpiece made of flat material. The folding device includes a machine frame having a flat mounting surface, at which a clamping cheek is arranged, which can be moved relative to the mounting surface. The clamping cheek clamps a workpiece which is positioned on the mounting surface at a specified or specifiable mounting position, to the machine frame. A bending means, of at least one bending tool can be moved relative to the mounting surface so that the clamped workpiece can be bent around a certain bending angle, is furthermore arranged at the folding device. A machine controller is coupled to a cutting tool drive of a cutting tool for cutting the workpiece and which for performing a cutting process for severing a workpiece which is smaller than a distance between the start position and the end position with respect to the bending axis.

### CROSS-REFERENCE TO RELATED PATENT APPLICATIONS

This patent application claims the benefit of priority to German Patent Application No. 10 2020 200 971.6, filed Jan. 28, 2020 and German Patent Application No. 10 2020 202 201.1, filed Feb. 20, 2020, the entire teachings and disclosures of both applications are incorporated herein by reference thereto.

### FIELD

The invention relates to a folding device for bending a workpiece according to the subject matter of claim 1 and further to a method for operating such a folding device.

### BACKGROUND OF THE INVENTION

Folding devices for bending workpieces of the above-mentioned type have been known for a long time. They serve the purpose of producing an arbitrary bending geometry from a workpiece, which is to be shaped, for example a flat material, such as, e.g. a sheet metal piece. For this purpose, a workpiece is clamped and is bent over several times. To bring the respective workpiece to a specified workpiece dimension, cutting, that is, trimming can advantageously be performed prior to and/or after the bending over. Cutting means are used for this purpose. It is a disadvantage of the known cutting means that the trimming of a workpiece is associated with relatively high expenditure of time.

### BRIEF SUMMARY OF THE INVENTION

It is thus the object of the invention to provide an improved or at least another embodiment of a folding device for bending a workpiece.

In the case of the present invention, this object is solved in particular by the subject matters of the independent claims. Advantageous embodiments are subject matter of the dependent claims and of the description.

It is the basic idea of the invention to specify a folding device, by means of which the machining of a workpiece is improved. An attempt is to in particular be made to accelerate the time for trimming a workpiece by means of a cutting means, thus to design it to be quicker.

For this purpose, a folding device for bending a workpiece made of flat material is provided, the flat material is sheet metal, for example. The folding device has a machine frame, which can advantageously be put down on a level ground and which has a flat mounting surface. At least one clamping cheek is arranged at the machine frame, said clamping cheek can be moved relative to the mounting surface and releasably clamps a workpiece positioned on the mounting surface at a mounting position to the machine frame. A bending means of at least one bending tool is furthermore arranged at the machine frame. The bending tool is designed so as to be capable of being moved relative to the mounting surface, so that the clamped workpiece can be bent at a certain bending angle. In addition, a cutting means of at least one cutting tool is arranged at the folding device, wherein the cutting tool can be moved back and forth between a start position and an end position relative to the mounting surface by means of a cutting tool drive as part of a working movement. As part of the working movement, the clamped workpiece can advantageously be severed completely by the cutting tool along a cutting axis. The mounting position is advantageously specified by means of a workpiece stop, which is arranged at the folding device, for positioning a workpiece, which is to be bent over and/or to be severed, the machine operator can further advantageously manually specify the mounting position by means of measuring. The folding device is designed such that the start position is arranged at the machine frame on one end, and the end position is arranged at the machine frame on the other end. A machine controller is provided, which is coupled to the cutting tool drive. To perform a cutting process for severing a workpiece, which is smaller than a distance between the start position and the end position with respect to a longitudinal machine axis, the machine controller automatically controls the cutting tool drive to move the cutting tool from the start position only to a workpiece end of the workpiece, which is spaced apart from the workpiece stop or from the start position, and from there back to the start position again. Immediately after passing a workpiece end of the respective workpiece, the cutting tool thus automatically moves back into the start position, instead of initially moving to the end position, and from there back to the start position again, independently of the workpiece end or a workpiece length, respectively, of the workpiece. As a result, the distance to be covered by the cutting tool for severing a workpiece can thus be reduced. Due to the reduced distance, machining time correlating with the respective workpiece length can be saved when severing a workpiece, so that the machining of a workpiece as a whole is cost-efficient. This advantage is significant in particular when the folding device is suitable for folding relatively large or long workpieces, respectively, e.g. more than 4 m. Such long folding devices, so-called long folding devices, are often also used to fold shorter workpieces, thus resulting in the described advantage.

It is advantageously provided that the machine controller has a sensor system, which determines a workpiece end of the workpiece, for example a workpiece edge of the respective workpiece, which is spaced apart from the workpiece stop. By determining a workpiece end of a workpiece by means of the sensor system, a reversing position, so to speak, can be determined, by means of which the cutting tool can be controlled by means of the machine controller.

The cutting tool can thus be systematically stopped while in motion and can be moved back to the end position.

The sensor system can in particular detect at least one cutting run state and at least one empty run state of the cutting tool, wherein an empty run state, which temporally immediately follows at least one cutting run state, can indicate a workpiece end of the workpiece, which is spaced apart from the workpiece stop. A logic is thus specified, based on which working states of the cutting tool can be assessed. Working states can be provided, for example, by a cutting run state, which identifies the state when the cutting tool engages with contact with the workpiece, and by an empty run state, which identifies the state when the cutting tool does not engage with the workpiece. The logic has the advantage that the cutting tool can be stopped and reversed directly at or relatively close to the workpiece end of the respective workpiece.

The sensor system can advantageously detect the power requirement of the cutting tool device. A relatively high power requirement can indicate a cutting run state, while a relatively low power requirement can indicate an empty run state. A detection of the working states of the cutting tool, which can be implemented in a structurally favorable manner, which operates quickly, and which can be easily integrated into existing folding devices, can thus be realized in an advantageous manner.

The machine controller and/or the sensor system can further advantageously be formed to use the electric conductivity of the workpiece in the case of electrically conductive workpieces. A conductive measuring current can in particular be detected by measurements, and a workpiece end of the respective workpiece can be detected based on the measured conductive measuring current.

Instead of one workpiece, several workpieces, which are separated from one another, quasi individual workpieces, can advantageously be arranged at the mounting surface. The workpieces are advantageously releasably clamped to the mounting surface with mutual distance from one another, wherein a workpiece-free gap is in each case defined between two adjacent workpieces. It is possible to set up the folding device such that the several workpieces are severed or cut and/or bent jointly, for the purpose of which, e.g. the number of the workpieces or the number of the gaps can be input or stored in the machine controller. In the alternative, the machine controller can be programmed. As a result, the cutting tool can pass over a specified or specifiable number of gaps between the respective workpieces or workpieces, before the cutting tool returns into its start position.

The sensor system can further advantageously detect the cutting run states and empty run states, which are to be detected, based on cutting measurement variables, which appear at the cutting tool. The working states of the cutting tool can advantageously be determined based on cutting measurement variables, which appear directly at the cutting tool.

To detect the cutting measurement variables of the cutting tool, the sensor system can advantageously have a signal emitter and/or a signal sensor. A signal emitter can thereby be formed by at least one laser emitter or by at least one light emitter, in particular a light curtain, or by at least one ultrasound emitter. A signal sensor can be formed by at least one laser sensor or by at least one light sensor, or by at least one ultrasound sensor, or by at least one Hall sensor. This has the advantage that the sensor system can advantageously be made up of common and in particular cost-efficient sensor system components, whereby the folding device as a whole is relatively cost-efficient.

The sensor system can advantageously have one or several workpiece detectors, which are arranged at the cutting tool along and/or transversely to the cutting axis upstream of and/or downstream from the cutting tool. The workpiece detectors can detect a workpiece, wherein the detection of the respective workpiece indicates a cutting run state, and wherein the non-detection indicates an empty run state. The presence of an unsevered workpiece, quasi the pipe workpiece, can be detected at the cutting tool by means of a workpiece detector, which is arranged upstream of the cutting tool in the direction of the cutting axis. The presence of a severed workpiece, for example a severed workpiece chip and the workpiece, which is cut to size, can furthermore be detected by means of a workpiece detector, which is arranged downstream from the cutting tool in the direction of the cutting axis. This has the advantage that the working states of the cutting tool can be detected relatively reliably and temporally relatively quickly.

The sensor system can further advantageously detect cutting run states and empty run states by means of a light curtain, which is arranged at the mounting surface. Along the longitudinal machine axis, the light curtain advantageously has light emitters, which are arranged with mutual distance to one another, and, along the longitudinal machine axis, has light sensors, which are arranged with mutual distance to one another. For example, emitter and sensor are in each case arranged opposite one another in pairs at the cutting tool, in order to measure appearing cutting measurement variables at the cutting tool. The cutting measurement variables can thereby be detected relatively quickly and relatively reliably at the cutting tool.

The sensor system can advantageously have a light curtain, which is arranged at the mounting surface. Along the longitudinal machine axis, the light curtain can advantageously have light emitters, which are arranged with mutual distance to one another, and, along the longitudinal machine axis, it can have light sensors, which are arranged with mutual distance to one another, wherein the light emitters and light sensors cooperate in order to detect a workpiece length, which is measured parallel with respect to the longitudinal machine axis between the start position and the end position, of a workpiece, which is positioned on the mounting surface, wherein the machine controller controls the cutting tool drive such that the cutting tool is automatically moved from the start position only to a workpiece end of the workpiece, which is spaced apart from the workpiece stop, and which is determined based on the measured workpiece length, and from there back to the start position again. Even though the cutting measurement variables cannot be detected at the cutting tool thereby, a reversing position, based on which the cutting tool can then be controlled accordingly by means of the machine controller, can be determined based on the measured workpiece length of a workpiece, which is positioned on the mounting surface. The cutting tool can thus stop while in motion and can move back to the end position. This has the advantage that the cutting tool can be stopped and reversed directly at or relatively close to the workpiece end of the respective workpiece. It goes without saying that cutting measurement variables can additionally also be detected at the cutting tool. For example, emitter and sensor are in each case arranged opposite one another in pairs at the cutting tool.

The cutting means can further advantageously have a guide rail, which is arranged in a stationary manner at the machine frame, and a movable tool carriage. The tool carriage can be arranged at the guide rail so as to be capable of being guided along the longitudinal machine axis, and can be capable of being moved in the direction of the longitudinal machine axis by means of the cutting tool drive. The tool carriage can furthermore have at least one tool receptacle, at which a cutting tool is arranged in each case. The respective cutting tool can thus advantageously be moved back and forth between the start position and the end position, in particular along a machine axis.

The cutting tool can advantageously have a cutting edge receptacle for receiving at least one cutting edge element of the cutting tool for completely severing the workpiece. It is advantageously attained therewith that a positioned workpiece can be completely severed in the direction of the cutting axis.

The sensor system can further advantageously detect a cutting edge engagement region of the cutting edge element with the workpiece. The cutting edge engagement region can be arranged at the cutting tool upstream of and/or downstream from the cutting edge element in the direction of the cutting axis. The cutting edge engagement region can advantageously form a direct contact region between cutting edge element and the workpiece to be severed, in that the cutting edge element abuts with contact on the tool. The cutting edge engagement region can be monitored in order to detect working states of the cutting tool. For example, a light barrier or the like, which is arranged at the cutting tool, can be envisaged, which monitors the cutting edge engagement region and detects whether or not a workpiece is present.

The sensor system is advantageously arranged at the cutting tool and/or at the machine frame. Depending on where the sensor system is arranged, the machine controller and/or the sensor system can be formed to communicate with one another wirelessly or by wire. This offers the advantageous effect that conductor cables, which enable a communication, can be forgone. The production of the folding device is thus relatively cost-efficiently.

To temporally optimize the folding by means of a folding device, i.e. to speed it up, the invention comprises the further basic idea of specifying a method for operating a folding device according to the preceding description. It is provided thereby that, e.g. by means of a sensor system of the folding device the termination of a severing process, i.e. of a cutting process, of a workpiece, which is preferably performed by means of the cutting tool, is detected. The cutting tool, which is moved along the longitudinal machine axis as part of the working movement, is then automatically stopped between the start position and the end position, for example at a so-called reversing position. The cutting tool is then automatically moved back into the start position. The method has the advantageous effect that the cutting tool automatically moves back into the start position immediately after passing a workpiece end of the respective workpiece. The necessity of initially moving back to the end position, and from there back to the start position again, becomes unnecessary. Machining time correlating with the respective workpiece length can thus be saved when severing a workpiece.

The workpiece stop and the start position can further advantageously define a transverse direction. The transverse direction stands at an angle or in particular at a right angle, on the longitudinal machine axis or a longitudinal machine axis of the folding device. This has the effect that the start position and the workpiece stop are arranged transversely to the working movement of the cutting tool. The start position and the workpiece stop can thus advantageously be arranged directly adjacent to one another.

In the direction of the longitudinal machine axis, the mounting surface can advantageously be arranged between the workpiece stop and the start position on the one hand, and the end position on the other hand. The end positions, which the cutting tool can approach as part of the working movement, are thus quasi always spaced apart from one another by the mounting surface. This has the advantage that a workpiece, which is positioned at the mounting surface, can be completely severed along the cutting axis.

A mounting position for a workpiece, which is to be positioned, can further advantageously be arranged directly at or in the region of the workpiece stop and the start position. A workpiece, which is positioned at the respective mounting position, is thus always arranged at the workpiece stop, so that said workpiece can be supported at the workpiece stop along the longitudinal machine axis.

To be able to store and evaluate measurement values determined by the sensor system for detecting cutting measurement variables, cutting run states, empty run states, and/or a power requirement, the sensor system advantageously has a processing unit, which, with a memory element and a computing element, serves to store and analyze the respective measurement values. The storing and analyzing can take place in real time. This has the advantageous effect that the machine controller can control the cutting tool drive quasi immediately and without hesitating to move the cutting tool from a workpiece end of the workpiece, which is spaced apart from the workpiece stop, back to the start position.

The folding device is advantageously a double folding device, which has two bending tools, in order to bend a clamped workpiece relative to the mounting surface in two different directions, in particular around the longitudinal machine axis. The respective workpiece can thus be bent arbitrarily, without having to turn it. The creation of arbitrary bending geometries is thus simplified.

A folding device for bending a workpiece made of flat material can advantageously be provided. It is equipped with a machine frame having a flat mounting surface, at which a clamping cheek is arranged, which can be moved relative to the mounting surface and which releasably clamps a workpiece, which is positioned on the mounting surface at a mounting position, to the machine frame. A bending device of at least one bending tool, which can be moved around a bending axis relative to the mounting surface in order to bend the clamped workpiece around the bending axis, can be arranged at the machine frame. In addition, a cutting means of at least one cutting tool can be arranged at the machine frame, which cutting tool can be moved back and forth between a start position and an end position relative to the mounting surface in the direction of the bending axis by means of a cutting tool drive as part of a working movement, in order to completely sever the clamped workpiece along a cutting axis, which is aligned parallel to the bending axis, wherein in the direction of the bending axis, the mounting position is specified by means of a workpiece stop, which is arranged at the machine frame, for positioning a workpiece, which is to be bent over and/or to be severed. The workpiece stop and the start position are thereby adjacent to one another and are arranged in the direction of the bending axis at the machine frame on one end, and the end position is arranged at the machine frame on the other end. The folding device further has a machine controller, which is coupled to the cutting tool drive and which, to perform a cutting process for severing a workpiece, which is smaller than a distance between the start position and the end position with respect to the bending axis, automatically controls the cutting tool drive to move the cutting tool from the start position only to a workpiece end of the workpiece, which is spaced apart from the workpiece stop, and from there back to the start position again.

The machine controller can advantageously have a sensor system, which determines a workpiece end of the workpiece, which is spaced apart from the workpiece stop.

The sensor system can further advantageously detect a cutting run state and an empty run state of the cutting tool, wherein an empty run state, which temporally immediately follows a cutting run state, indicates a workpiece end of the workpiece, which is spaced apart from the workpiece stop.

The sensor system can advantageously detect the power requirement of the cutting tool drive, wherein a relatively high power requirement indicates a cutting run state, and a relatively low power requirement indicates an empty run state.

The sensor system can further advantageously detect cutting run states and empty run states based on cutting measurement variables, which appear at the cutting tool. To detect the cutting measurement variables of the cutting tool, the sensor system can advantageously have a signal emitter and/or a signal sensor, wherein the signal emitter is formed by at least one laser emitter, by at least one light emitter, in particular a light curtain, or by at least one ultrasound emitter, and/or wherein the signal sensor is formed by at least one laser sensor, by at least one light sensor, or by at least one ultrasound sensor, or by at least one Hall sensor.

The sensor system can advantageously have a workpiece detector, which is arranged at the cutting tool upstream of and/or downstream from the cutting tool in the direction of the cutting axis and which detects a workpiece, wherein the detection of a workpiece indicates a cutting run state, and wherein the non-detection indicates an empty run state.

The sensor system can further advantageously detect cutting run states and empty run states by means of a light curtain, which is arranged at the mounting surface, wherein, along the bending axis, the light curtain has light emitters, which are arranged with mutual distance to one another, and, along the bending axis, has light sensors, which are arranged with mutual distance to one another, and which measure cutting measurement variables appearing at the cutting tool.

The sensor system can advantageously have a light curtain, which is arranged at the mounting surface and which, along the bending axis, has light emitters, which are arranged with mutual distance to one another, and, along the bending axis, has light sensors, which are arranged with mutual distance to one another, wherein the light emitters and light sensors cooperate in order to detect a workpiece length, which is measured parallel with respect to the bending axis between the start position and the end position, of a workpiece, which is positioned on the mounting surface, wherein the machine controller controls the cutting tool drive such that the cutting tool is automatically moved from the start position only to a workpiece end of the workpiece, which is spaced apart from the workpiece stop, and which is determined based on the measured workpiece length, and from there back to the start position again.

The cutting means can further advantageously have a guide rail, which is arranged at the machine frame, and a tool carriage, wherein the tool carriage can be arranged at the guide rail so as to be capable of being guided along the bending axis, and can be moved in the direction of the bending axis by means of the cutting tool drive, wherein the tool carriage furthermore supports the cutting tool at a tool receptacle.

The cutting tool can advantageously have a cutting edge receptacle for receiving at least one cutting edge element of the cutting tool for completely severing the workpiece.

The sensor system can further advantageously detect a cutting edge engagement region of the cutting edge element with the workpiece, which cutting edge engagement region is arranged at the cutting tool upstream of and/or downstream from the cutting edge element in the direction of the cutting axis.

The sensor system can advantageously be arranged at the cutting tool and/or at the machine frame.

The machine controller and/or the sensor system can be formed to communicate with one another wirelessly or by wire.

A method for operating a folding device of the above-described type can advantageously be provided, in the case of which, e.g. by means of a sensor system of the folding device, the termination of a severing process of a workpiece, which is preferably performed by means of the cutting tool, is detected, the cutting tool, which is moved as part of the working movement, is then stopped between the start position and the end position, and the cutting tool then further moves back into the start position. The machine controller of the folding device can be designed and/or programmed to carry out this method.

A folding device for bending a workpiece made of flat material can advantageously furthermore be provided, the flat material is sheet metal, for example. The folding device can have a machine frame, which can advantageously be put down on a level ground and which has a flat mounting surface. At least one clamping cheek, which can be moved relative to the mounting surface and which releasably clamps a workpiece positioned on the mounting surface at a mounting position to the machine frame, can be arranged at the machine frame. A bending means of at least one bending tool can furthermore be arranged at the machine frame, wherein the bending tool is designed so as to be capable of being moved around a bending axis relative to the mounting surface, so that the clamped workpiece can be bent around the bending axis. In addition, a cutting means of at least one cutting tool can be arranged at the machine frame, wherein the cutting tool can be moved back and forth between a start position and an end position relative to the mounting surface by means of a cutting tool drive as part of a working movement. As part of the working movement, the clamped workpiece can advantageously be severed completely by the cutting tool along a cutting axis, which is aligned parallel to the bending axis. In the direction of the bending axis, the mounting position can be specified by means of a workpiece stop, which is arranged at the machine frame, in particular a laser means or a machine stop, for positioning a workpiece, which is to be bent over and/or to be severed. The folding device can advantageously be designed such that the workpiece stop and the start position are adjacent to one another and are arranged at the machine frame on one end in the direction of the bending axis, while the end position is arranged at the machine frame on the other end. In addition, a machine controller is advantageously provided, which is coupled to the cutting tool drive. To perform a cutting process for severing a workpiece, which is smaller than a distance between the start position and the end position with respect to a the bending axis, the machine controller automatically controls the cutting tool drive to move the cutting tool from the start position only to a workpiece end of the workpiece, which is spaced apart from the workpiece stop, and from there back to the start position again. Immediately after passing a workpiece end of the respective workpiece, the cutting tool thus automatically moves back into the start position, instead of initially moving to the end position, and from there back to the start position again, independently of the workpiece end or a workpiece length, respectively, of the workpiece. As a result, the distance to be covered by the cutting tool for severing a workpiece can thus be reduced. Due to the reduced distance, machining time correlating with the respective workpiece length can be saved when severing a workpiece, so that the machining of a workpiece as a whole is cost-efficient. This advantage is significant in particular when the folding device is suitable for folding relatively large or long workpieces, respectively, e.g. more than 4 m. Such long folding devices, so-called long folding devices, are often also used to fold shorter workpieces, thus resulting in the described advantage.

It is advantageously provided that the machine controller has a sensor system, which determines a workpiece end of the workpiece, for example a workpiece edge of the respective workpiece, which is spaced apart from the workpiece stop. By determining a workpiece end of a workpiece by means of the sensor system, a reversing position, so to speak, can be determined, by means of which the cutting tool can be controlled by means of the machine controller. The cutting tool can thus be systematically stopped while in motion and can be moved back to the end position.

The sensor system can in particular detect at least one cutting run state and at least one empty run state of the cutting tool, wherein an empty run state, which temporally immediately follows at least one cutting run state, can indicate a workpiece end of the workpiece, which is spaced apart from the workpiece stop. A logic is thus specified, based on which working states of the cutting tool can be assessed. Working states can be provided, for example, by a cutting run state, which identifies the state when the cutting tool engages with contact with the workpiece, and by an empty run state, which identifies the state when the cutting tool does not engage with the workpiece. The logic has the advantage that the cutting tool can be stopped and reversed directly at or relatively close to the workpiece end of the respective workpiece.

The sensor system can advantageously detect the power requirement of the cutting tool device. Relatively high power requirement can indicate a cutting run state, while a relatively low power requirement can indicate an empty run state. A detection of the working states of the cutting tool, which can be implemented in a structurally favorable manner, which operates temporally quickly, and which can be easily integrated into existing folding devices, can thus be realized in an advantageous manner.

The sensor system can further advantageously detect the cutting run states and empty run states, which are to be detected, based on cutting measurement variables, which appear at the cutting tool. The working states of the cutting tool can advantageously be determined based on cutting measurement variables, which appear directly at the cutting tool.

To detect the cutting measurement variables of the cutting tool, the sensor system can advantageously have a signal emitter and/or a signal sensor. A signal emitter can thereby be formed by at least one laser emitter, or by at least one light emitter, in particular a light curtain, or by at least one ultrasound emitter. A signal sensor can be formed by at least one laser sensor, or by at least one light sensor, or by at least one ultrasound sensor, or by at least one Hall sensor. This has the advantage that the sensor system can advantageously be made up of common and in particular cost-efficient sensor system components, whereby the folding device as a whole is relatively cost-efficient.

The sensor system can advantageously have one or several workpiece detectors arranged at the cutting tool in the direction of the cutting axis upstream of and/or downstream from the cutting tool. The workpiece detectors can detect a workpiece, wherein the detection of the respective workpiece indicates a cutting run state, and wherein the non-detection indicates an empty run state. The presence of an unsevered workpiece, quasi the pipe workpiece, can be detected at the cutting tool by means of a workpiece detector, which is arranged upstream of the cutting tool in the direction of the cutting axis. The presence of a severed workpiece, for example a severed workpiece chip and the workpiece, which is cut to size, can furthermore be detected by means of a workpiece detector, which is arranged downstream from the cutting tool in the direction of the cutting axis. This has the advantage that the working states of the cutting tool can be detected relatively reliably and temporally relatively quickly.

The sensor system can further advantageously detect cutting run states and empty run states by means of a light curtain, which is arranged at the mounting surface. Along the bending axis, the light curtain advantageously has light emitters, which are arranged with mutual distance to one another, and, along the bending axis, has light sensors, which are arranged with mutual distance to one another. For example, emitter and sensor are in each case arranged opposite one another in pairs at the cutting tool, in order to measure appearing cutting measurement variables at the cutting tool. The cutting measurement variables can thereby be detected relatively quickly and relatively reliably at the cutting tool.

The sensor system can advantageously have a light curtain, which is arranged at the mounting surface. Along the bending axis, the light curtain can advantageously have light emitters, which are arranged with mutual distance to one another, and, along the bending axis, it can have light sensors, which are arranged with mutual distance to one another, wherein the light emitters and light sensors cooperate in order to detect a workpiece length, which is measured parallel with respect to the bending axis between the start position and the end position, of a workpiece, which is positioned on the mounting surface, wherein the machine controller controls the cutting tool drive such that the cutting tool is automatically moved from the start position only to a workpiece end of the workpiece, which is spaced apart from the workpiece stop, and which is determined based on the measured workpiece length, and from there back to the start position again. Even though the cutting measurement variables cannot be detected at the cutting tool thereby, a reversing position, based on which the cutting tool can then be controlled accordingly by means of the machine controller, can be determined based on the measured workpiece length of a workpiece, which is positioned on the mounting surface. The cutting tool can thus stop while in motion and can move back to the end position. This has the advantage that the cutting tool can be stopped and reversed directly at or relatively close to the workpiece end of the respective workpiece. It goes without saying that cutting measurement variables can additionally also be detected at the cutting tool. For example, emitter and sensor are in each case arranged opposite one another in pairs at the cutting tool.

The cutting means can further advantageously have a guide rail, which is arranged in a stationary manner at the machine frame, and a movable tool carriage. The tool carriage can be arranged at the guide rail so as to be capable of being guided along the bending axis, and can be capable of being moved in the direction of the bending axis by means of the cutting tool drive. The tool carriage can furthermore have at least one tool receptacle, at which a cutting tool is arranged in each case. The respective cutting tool can thus advantageously be moved back and forth between the start position and the end position.

The cutting tool can advantageously have a cutting edge receptacle for receiving at least one cutting edge element of the cutting tool for completely severing the workpiece. It is advantageously attained therewith that a positioned workpiece can be completely severed in the direction of the cutting axis.

The sensor system can further advantageously detect a cutting edge engagement region of the cutting edge element with the workpiece. The cutting edge engagement region can be arranged at the cutting tool upstream of and/or downstream from the cutting edge element in the direction of the cutting axis. The cutting edge engagement region can advantageously form a direct contact region between cutting edge element and the workpiece to be severed, in that the cutting edge element abuts with contact on the tool. The cutting edge engagement region can be monitored in order to detect working states of the cutting tool. For example, a light barrier or the like, which is arranged at the cutting tool, can be envisaged, which monitors the cutting edge engagement region and detects whether or not a workpiece is present.

The sensor system is advantageously arranged at the cutting tool and/or at the machine frame. Depending on where the sensor system is arranged, the machine controller and/or the sensor system can be formed to communicate with one another wirelessly or by wire. This offers the advantageous effect that conductor cables, which enable a communication, can be forgone. The production of the folding device is thus relatively cost-efficiently.

To temporally optimize the folding by means of a folding device, i.e. to speed it up, the invention comprises the further basic idea of specifying a method for operating a folding device according to the preceding description. It is provided thereby that, e.g. by means of a sensor system of the folding device the termination of a severing process, i.e. of a cutting process, of a workpiece, which is advantageously performed by means of the cutting tool, is detected. The cutting tool, which is moved along the bending axis as part of the working movement, is then stopped at the workpiece, thus between the start position and the end position, for example at a so-called reversing position. The cutting tool is then further moved back into the start position. The cutting tool is thereby moved out of the reversing position into the start position with reversed direction of movement with respect to the working movement. The method has the advantageous effect that the cutting tool automatically moves back into the start position immediately after passing a workpiece end of the respective workpiece. The necessity of initially moving to the end position, and from there back to the start position again, becomes unnecessary. Machining time correlating with the respective workpiece length can thus be saved when severing a workpiece.

The workpiece stop and the start position can further advantageously define a transverse direction. The transverse direction stands at an angle or in particular at a right angle, on the bending axis. This has the effect that the start position and the workpiece stop are arranged transversely to the working movement of the cutting tool. The start position and the workpiece stop can thus advantageously be arranged directly adjacent to one another.

In the direction of the bending axis, the mounting surface can advantageously be arranged between the workpiece stop and the start position on the one side, and the end position on the other side. The end positions, which the cutting tool can approach as part of the working movement, are thus quasi always spaced apart from one another by the mounting surface. This has the advantage that a workpiece, which is positioned at the mounting surface, can be completely severed along the bending axis.

A mounting position for a workpiece, which is to be positioned, can further advantageously be arranged directly at or in the region of the workpiece stop and the start position. A workpiece, which is positioned at the respective mounting position, is thus always arranged at the workpiece stop, so that said workpiece can be supported at the workpiece stop along the bending axis.

To be able to store and evaluate measurement values determined by the sensor system for detecting cutting measurement variables, cutting run states, empty run states, and/or a power requirement, the sensor system advantageously has a processing unit, which, with a memory element and a computing element, serves to store and analyze the respective measurement values. The storing and analyzing can take place in real time. This has the advantageous effect that the machine controller can control the cutting tool drive quasi immediately and without hesitating to move the cutting tool from a workpiece end of the workpiece, which is spaced apart from the workpiece stop, back to the start position.

In summary, it should be pointed out: The present invention preferably relates to a folding device for bending a workpiece made of flat material, comprising a machine frame having a flat mounting surface, at which a clamping cheek is arranged, which can be moved relative to the mounting surface. The clamping cheek clamps a workpiece, which is positioned on the mounting surface at a specified or specifiable mounting position, to the machine frame. A bending means of at least one bending tool is furthermore arranged at the machine frame, which can be moved relative to the mounting surface, so that the clamped workpiece can be bent at a certain bending angle. It is essential that a machine controller is provided, which is coupled to a cutting tool drive of a cutting tool for cutting the workpiece, and which, for performing a cutting process for severing a workpiece, which is smaller than a distance between the start position and the end position with respect to the bending axis or a longitudinal machine axis, automatically controls the cutting tool drive to move the cutting tool from the start position only to a workpiece end of the workpiece, which is spaced apart therefrom, and from there back to the start position again.

Further important features and advantages of the invention follow from the subclaims, from the drawings, and from the corresponding figure description on the basis of the drawings.

It goes without saying that the above-mentioned features and the features, which will be described below, cannot only be used in the respective specified combination, but also in other combinations or alone, without leaving the scope of the present invention.

### BRIEF DESCRIPTION OF THE FIGURES

Preferred exemplary embodiments of the invention are illustrated in the drawings and will be described in more detail in the following description, whereby identical reference numerals refer to identical or similar or functionally identical components.

In each case schematically,

FIG. 1 shows a perspective view of a preferred exemplary embodiment of a folding device, wherein a workpiece, which is positioned at the folding device, is cut by means of a cutting means,

FIG. 2 shows a view of the cutting means of the folding device from FIG. 1, viewed in the direction of an arrow II entered there,

FIG. 3 shows a view of the cutting means of the folding device from FIG. 1, viewed in the direction of an arrow III entered there, wherein a workpiece chip is removed.

### DETAILED DESCRIPTION OF THE INVENTION

The drawings 1 to 3 show a preferred exemplary embodiment of a folding device, which is labeled as a whole with reference numeral 1, which is also known as long folding device within the corresponding professional circles. Folding devices serve the purpose of bending workpieces 2 made of flat material in order to produce arbitrary bending geometries.

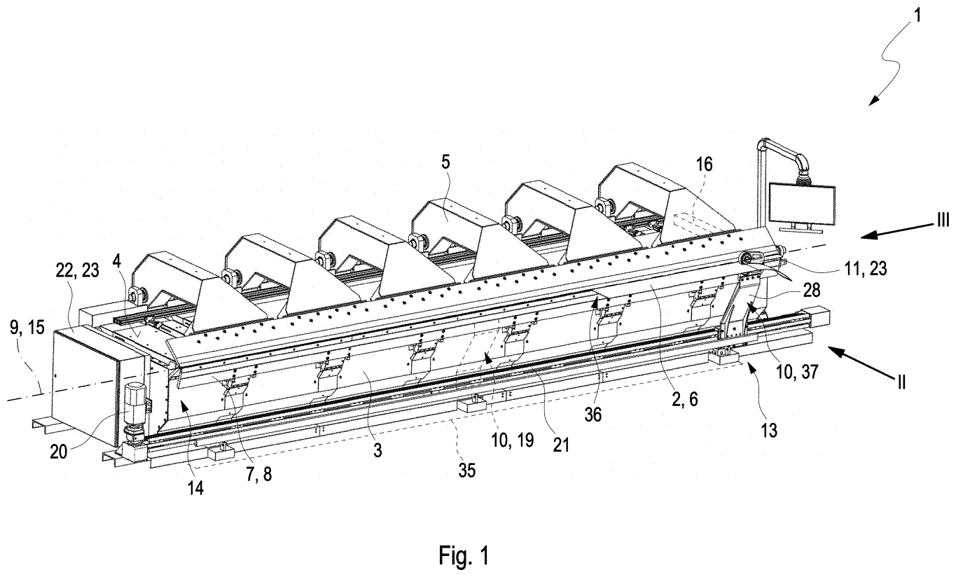

The folding device 1 according to FIG. 1 is illustrated in a perspective view. The folding device 1 has a machine frame 3 comprising a flat mounting surface 4. The machine frame 3 is put down on a level ground, which is not illustrated, so that the mounting surface 4 faces upwards, which could be described as use position. A clamping cheek 5, which can be moved relative to the mounting surface 4, is arranged in any case at the machine frame 3, which clamping cheek in this case releasably clamps a workpiece 2, which is positioned on the mounting surface 4 at a mounting position 6, is pre-clamped and laterally overlaps with respect to the mounting surface 4, to the machine frame 3. A bending means 7 of at least one bending tool 8 is furthermore arranged at the machine frame 3. The bending tool 8 is designed, as an example, in a non-operated rest state. In a non-illustrated operated active state, which deviates from the non-operated rest state, the bending tool 8 is moved relative to the mounting surface 4, so that the clamped workpiece 2 can be bent around a longitudinal machine axis 9 or a bending axis 9, respectively, at a certain bending angle.

A type of long folding machines is also not illustrated, which, in addition to a first lower bending tool, also have a second upper bending tool. With the two bending tools, bending can be performed in both directions, without having to turn the workpiece.

A cutting means, which is identified with reference numeral 10 and which is arranged at the folding device 1, together with a cutting tool 11 for cutting the workpiece 2 to size as part of a working movement 12, can be moved back and forth between a start position 13 and an end position 14 relative to the mounting surface 4 in the direction of the longitudinal machine axis 9 or the bending axis 9, respectively. The cutting means 10 advantageously has a tool carriage 28, which, in this case, can be guided at a guide rail 21, which is attached to the machine frame 3. To drive the cutting means 10, a cutting tool drive 20 is provided as an example, which is arranged at the machine frame 3 and which is coupled to the cutting means 10 or to the tool carriage 28, respectively, see FIG. 1.

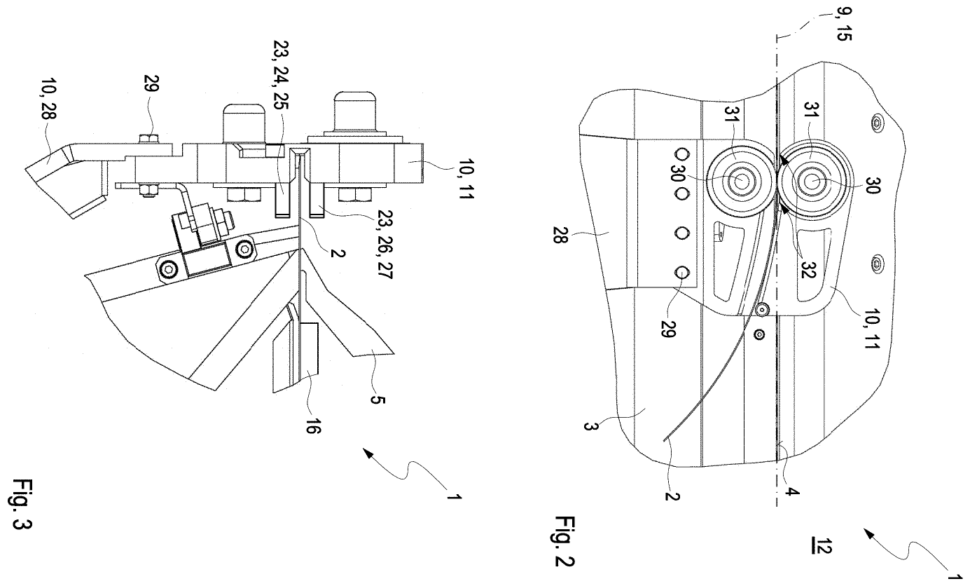

In a view, FIG. 2 shows, among other things, the cutting means 10, which is arranged at the machine frame 3, comprising cutting tool 11, whereby it can be seen in more detail here that the tool carriage 28 has a tool receptacle 29, to which the cutting tool 11 is linked. As an example, the cutting tool 11, in turn, has two cutting edge receptacles 30, which each serve to receive at least one cutting edge element 31. In each case or together, the workpiece 2 can be severed completely by means of the cutting edge elements 31 along the cutting axis 15, which, as an example, is aligned parallel to the longitudinal machine axis 9 or to the bending axis 9, respectively.

FIG. 3 shows the cutting means 10 from FIG. 1 in a further view, whereby a workpiece stop 16 can be seen, which is arranged at the machine frame 3 and which specifies the mounting position 6 in the direction of the longitudinal machine axis 9 or of the bending axis 9, respectively. The workpiece 2, which is to be severed, can be positioned at the workpiece stop 16 or can quasi be aligned along the longitudinal machine axis 9 or the bending axis 9, respectively, for example in order to bend it over and/or to sever it.

It can further be seen in FIG. 1 that the workpiece stop 16 and the start position 13 are selected such that they are adjacent to one another and are arranged at the machine frame 3 on one end in the direction of the longitudinal machine axis 9 or of the bending axis 9, respectively, while the end position 14 is arranged at the machine frame 3 on the other end.

The folding device 1 furthermore has a machine controller 22, see FIG. 1, which is coupled to the cutting tool drive 20. The machine controller 22 is provided to control the cutting tool drive 20 and thus to perform a cutting process for severing a workpiece 2, wherein it automatically controls the cutting tool drive 20 to move the cutting tool 11 from the start position 13 only to a workpiece end 36 of the workpiece 2, which is spaced apart from the workpiece stop 16, and from there back to the start position 13 again. With respect to the longitudinal machine axis 9 or the bending axis 9, respectively, the workpiece 2 is thereby smaller than a distance 35 between the start position 13 and the end position 14.

In the present case, a sensor system 23 for detecting cutting run states 37 and empty run states 19 of the cutting tool 11 is provided, whereby workpiece ends 36 of a workpiece 2 can be detected based on these working states; an empty run state 19, which temporally immediately follows a cutting run state 37, generally indicates a workpiece end 36 of the workpiece 2, which is spaced apart from the workpiece stop 16. As an example, the sensor system 23 is embodied in several parts in the present case, namely as an example comprising a first part of the sensor system 23, arranged at the cutting means 10 and/or the cutting tool 11, and a second part of the sensor system 23, arranged at the machine controller 22. The sensor system 23, which is arranged at the machine controller 22, advantageously detects a workpiece end 36 of the workpiece 2, which is spaced apart from the workpiece stop 16, in that the power requirement of the cutting tool drive 20 is monitored.

As an example, it can be seen in FIG. 3 that the sensor system 23, which is arranged at the cutting means 10 and/or at the cutting tool 11, for detecting the cutting run states 37 and the empty run states 19, has a signal emitter 24 and a signal sensor 26. The signal emitter 24 is advantageously formed by at least one laser emitter 25, and the signal sensor 26 is advantageously formed by at least one laser sensor 27. The laser sensor 27 and the signal sensor 26 can, in the form of a workpiece detector, detect a cutting edge engagement region 32 of the cutting edge element 31, which is arranged at the cutting tool 11 upstream of and/or downstream from the cutting tool 11 in the direction of the cutting axis 15, with of the workpiece 2, wherein the detection of a workpiece 2 indicates a cutting run state 37, and wherein the non-detection indicates an empty run state 19, see FIG. 2.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A folding device for bending a workpiece made of flat material,
comprising a machine frame (3) having a flat mounting surface (4), at which a clamping cheek (5) is arranged, which can be moved relative to the mounting surface (4) and which releasably clamps a workpiece (2), which is positioned on the mounting surface (4) at a mounting position (6), to the machine frame (3),
wherein at least one bending means (7) of at least one bending tool (8), which can be moved relative to the mounting surface (4) in order to bend the clamped workpiece (2) around a specified or specifiable bending angle, is arranged at the folding device (1),
wherein a cutting means (10) of at least one cutting tool (11) is arranged at the folding device (1), which cutting tool can be moved back and forth between a start position (13) and an end position (14) relative to the mounting surface (4) in the direction of a longitudinal machine axis (9) by means of a cutting tool drive (20) as part of a working movement (12), in order to completely sever the clamped workpiece (2) along a cutting axis (15),
wherein the mounting position (6) transversely to the longitudinal machine axis (9) is specified by means of a workpiece stop (16), which is arranged at the machine frame (3), for positioning a workpiece (2), which is to be bent over and/or to be severed,
wherein the start position (13) is arranged at the machine frame (3) on one end, and the end position (14) is arranged at the machine frame (3) on the other end, and
wherein a machine controller (22) is provided, which is coupled to the cutting tool drive (20) and which, to perform a cutting process for severing a workpiece (2), which is smaller than a distance (35) between the start position (13) and the end position (14) with respect to the longitudinal machine axis (9), automatically controls the cutting tool drive (20) to move the cutting tool (11) from the start position (13) only to a workpiece end (36) of the workpiece (2), which is spaced apart from the start position (13), and from there back to the start position again (13).

2. The device according to claim 1,
wherein
the machine controller (22) has a sensor system (23), which determines a workpiece end (36) of the workpiece (2), which is spaced apart from the start position (13).

3. The device according to claim 2,
wherein
the sensor system (23) detects a cutting run state (37) and an empty run state (19) of the cutting tool (11), wherein an empty run state (19), which temporally immediately follows a cutting run state (37), indicates a workpiece end (36) of the workpiece (2), which is spaced apart from the start position (13).

4. The device according to claim 3,
wherein
the sensor system (23) detects the power requirement of the cutting tool drive (20), wherein a relatively high power requirement indicates a cutting run state (37), and a relatively low power requirement indicates an empty run state (19).

5. The device according to claim 2,
wherein
the sensor system (23) detects cutting run states (37) and empty run states (19) based on cutting measurement variables, which appear at the cutting tool (11).

6. The device according claim 5,
wherein
to detect the cutting measurement variables of the cutting tool (11), the sensor system (23) has a signal emitter (24) and/or a signal sensor (26), wherein
the signal emitter (24) is formed by at least one laser emitter (25), by at least one light emitter, in particular a light curtain, or by at least one ultrasound emitter, and/or
the signal sensor (26) is formed by at least one laser sensor (27), by at least one light sensor, or by at least one ultrasound sensor, or by at least one Hall sensor.

7. The device according to claim 5,
wherein
the sensor system (23) has a workpiece detector, which is arranged at the cutting tool (11) upstream of and/or downstream from the cutting tool (11) in and/or transversely to the direction of the cutting axis (15) and which detects a workpiece (2), wherein the detection of a workpiece (2) indicates a cutting run state (37), and wherein the non-detection indicates an empty run state (19).

8. The device according to claim 2,
wherein,
the sensor system (23) detects cutting run states (37) and empty run states (19) by means of a light curtain, which is arranged at the mounting surface (4), wherein along the longitudinal machine axis (9), the light curtain has light emitters, which are arranged with mutual distance to one another, and, along the longitudinal machine axis (9), has light sensors which are arranged with mutual distance to one another and which measure cutting measurement variables appearing at the cutting tool (11).

9. The device according to claim 8,
wherein
the sensor system (23) has a light curtain, which is arranged at the mounting surface (4) and which, along the longitudinal machine axis (9), has light emitters, which are arranged with mutual distance to one another, and, along the longitudinal machine axis (9), has light sensors, which are arranged with mutual distance to one another, wherein the light emitters and light sensors cooperate in order to detect a workpiece length (38), which is measured parallel with respect to the longitudinal machine axis (9) between the start position (13) and the end position (14), of a workpiece (2), which is positioned on the mounting surface (4), wherein the machine controller (22) controls the cutting tool drive (20) such that the cutting tool (11) is automatically moved from the start position (13) only to a workpiece end (36) of the workpiece (2), which is spaced apart from the workpiece stop (16), and which is determined based on the measured workpiece length (38), and from there back to the start position (13) again.

10. The device according to claim 1,
wherein
the cutting means (10) has a guide rail (21), which is arranged at the folding device (1) and a tool carriage (28), wherein the tool carriage (28) is arranged at the guide rail (21) so as to be capable of being guided along the longitudinal machine axis (9), and can be capable of being moved in the direction of the longitudinal machine axis (9) by means of the cutting tool drive (20), wherein the tool carriage (28) furthermore supports the cutting tool (11) at a tool receptacle (29).

11. The device according to claim 2,
wherein
the cutting tool (11) has a cutting edge receptacle (30) for receiving at least one cutting edge element (31) of the cutting tool (11) for completely severing the workpiece (2).

12. The device according to claim 11,
wherein
the sensor system (23) detects a cutting edge engagement region (32) of the cutting edge element (31) with the workpiece (2), which is arranged at the cutting tool (11) upstream of or downstream from the cutting edge element (31) in the direction of the cutting axis (15).

13. The device according to claim 2,
wherein
the sensor system (23) is arranged at the cutting tool (11) and/or at the machine frame (3).

14. The device according to claim 2,
wherein
the machine controller (22) and/or the sensor system (23) are formed to communicate with one another wirelessly or by wire.

15. The device according to claim 2,
wherein
in the case of electrically conductive workpieces (2), the machine controller (22) and/or the sensor system (23) are formed to detect a conductive measuring current by means of measuring, in order to determine the electrical conductivity of the respective workpiece (2), in order to detect a workpiece end (36) of the workpiece (2).

16. The device according to claim 1,
wherein
instead of one workpiece (2), several workpieces (2), which are separated from one another and which are releasably clamped to the mounting surface (4) with mutual distance from one another, are arranged at the mounting surface (4), wherein a workpiece-free gap is in each case defined between two adjacent workpieces (2), wherein the folding device (1) is set up to sever and/or to bend over the several workpieces (2) jointly, wherein the number of the workpieces (2) or the number of the gaps can be stored in the machine controller (22), in order to have the cutting tool (11) pass over a specified or specifiable number of gaps and/or workpieces (2) as part of a cutting process, before the cutting tool (11) returns into the start position (13).

17. The device according to claim 1,
wherein
the folding device (1) is a double folding device, which has two bending tools (8), in order to bend a workpiece (2) relative to the mounting surface (4) in two different directions around a longitudinal machine axis (9)

18. A method for operating a folding device according to claim 1, wherein the termination of a severing process of a workpiece (2) is detected, the cutting tool (11), which is moved as part of the working movement (12), is then stopped between the start position (13) and the end position (14), and the cutting tool (11) is then further moved back into the start position (13).

19. A folding device for bending a workpiece made of flat material, in particular according to claim 1,
comprising a machine frame (3) having a flat mounting surface (4), at which a clamping cheek (5) is arranged, which can be moved relative to the mounting surface (4) and which releasably clamps a workpiece (2), which is positioned on the mounting surface (4) at a mounting position (6), to the machine frame (3),
wherein a bending means (7) of at least one bending tool (8), which can be moved relative to the mounting surface (4) around a bending axis (9) in order to bend the clamped workpiece (2) around the bending axis (9), is arranged at the machine frame (3),
wherein a cutting means (10) of at least one cutting tool (11) is arranged at the machine frame (3), which cutting tool can be moved back and forth between a start position (13) and an end position (14) relative to the mounting surface (4) in the direction of the bending axis (9) by means of a cutting tool drive (20) as part of a working movement (12), in order to completely sever the clamped workpiece (2) along a cutting axis (15), which is aligned parallel to the bending axis (9),
wherein in the direction of the bending axis (9), the mounting position (6) is specified by means of a workpiece stop (16), which is arranged at the machine frame (3), for positioning a workpiece (2), which is to be bent over and/or to be severed,
wherein the workpiece stop (16) and the start position (13) are adjacent to one another and are arranged in the direction of the bending axis (9) at the machine frame (3) on one end, and the end position (14) is arranged at the machine frame (3) on the other end, and
wherein a machine controller (22) is provided, which is coupled to the cutting tool drive (20) and which, to perform a cutting process for severing a workpiece (2), which is smaller than a distance (35) between the start position (13) and the end position (14) with respect to the bending axis (9), automatically controls the cutting tool drive (20) to move the cutting tool (11) from the start position (13) only to a workpiece end (36) of the workpiece (2), which is spaced apart from the workpiece stop (16), and from there back to the start position (13) again.
